(19) United States
(12) Patent Application Publication
(10) Pub. No.: US 2014/0188613 A1
(43) Pub. Date: Jul. 3, 2014

(54) PROVIDING PROMOTIONAL CONTENT

(71) Applicant: CELLCO PARTNERSHIP D/B/A VERIZON WIRELESS, Basking Ridge, NJ (US)

(72) Inventor: Nagaraju MANCHIRAJU, Bridgewater, NJ (US)

(73) Assignee: CELLCO PARTNERSHIP D/B/A VERIZON WIRELESS, Basking Ridge, NJ (US)

(21) Appl. No.: 13/731,702

(22) Filed: Dec. 31, 2012

(51) Int. Cl. G06Q 30/02

(52) U.S. Cl. CPC G06Q 30/0259
USPC 705/14.57

(57) ABSTRACT

Systems and methods for providing promotional content are disclosed. A product or service inquiry is received at a portal computer system of one of a number of providers that are affiliated for cross-channel sales. A location is determined where a communication product or service will be provided for a customer, in relation to the inquiry. A subset of the affiliated providers that offer a communication product or service corresponding to the inquiry for the determined location is identified. For each respective provider among the subset of affiliated providers, promotional content for a respective communication product or service corresponding to the inquiry for the determined location and information indicating the respective provider are obtained from a computer system of the respective provider. The obtained promotional content is transmitted from the portal computer system for presentation to the customer.

### BACKGROUND

In recent years, the spread of electronic commerce has allowed users to conveniently obtain products and/or services in many geographical locations that support internet access. A user who desires to purchase a product and/or service from a specific provider can conveniently engage in a transaction with the provider. However, the provider often has multiple promotions available for the desired product and/or service, some of which may not be easily identified by the user. Furthermore, the user may also wish to search for products and/or services that are offered by other providers, and compare products and/or services offered by different providers. While the user may perform comparisons of products and/or services by separately visiting each of the providers' respective websites to compare the products and services, this process would be tedious.

Company affiliations arise, e.g. within corporate families and/or via contractual arrangements, in which one service provider may provide information content for comparison or even conduct sales transactions for equipment or services of another provider operating in the same geographic region or in overlapping geographic regions.

Within a corporate family of closely related enterprises, proprietary information about customers as well as product or service offerings of various enterprises within the family may be shared between those closely related enterprises. For example, to maximize overall sales to customers within the family an enterprise offering mobile wireless communication services may share information with an enterprise within the same corporate family that offers landline telephone, internet and television services. In this way, landline services can readily be offered and sold to wireless customers; and wireless products and services can readily be offered and sold to wireless customers. Although there is some competition between the entities, e.g. replacement of landline services with wireless services, the close corporate relationship dictates cross-channel marketing on behalf of multiple entities within the family for the overall maximum benefit of the larger corporate family.

Where enterprises compete in some or all markets, however, cross-channel marketing and related sharing of information between enterprises is more problematic. Consider another telecommunication example. In many areas, a cable service provider offers telephone, internet and television services in direct competition with similar services now offered by local telephone companies. In such scenarios, cable and telephone companies are loath to share information, for example, about their customers, products, services, pricing, etc. Also, government entities may view sharing of information between companies offering the same or similar services as actual or potential anti-competitive behavior.

However, there may be situations/areas in which sharing information to enable cross-channel marketing efforts and sales via companies that compete in at least some markets actually promote competition with other companies. For example, most cable television service providers do not currently offer mobile wireless service. Agreement with one or more cable televisions service providers may give a mobile wireless carrier additional marketing and sales opportunities and improve the wireless carrier's ability to compete with other wireless service providers. A landline telephone company often offers services in somewhat limited geographic areas. If the landline telephone company has a wireless affiliate, it may be advantageous to offer wireless customers landline telephone company services in one area and offer services of a cable television service provider in another area.

As shown even by the outline regarding communication providers above, the relationships between various service/product providers can be very complex. At times, through corporate relationships and/or contractual agreements, it is desirable to implement cross-channel sales. Even where they compete directly head to head, customers or prospective customers often desire comparisons of features and pricing of the competitive products or services. Each of the service providers, however, typically is limited to proprietary content delivery channels and end-user devices that are approved for that service provider, when delivering promotional content to prospective customers. Also, the companies involved may still want to maintain as much control over their information and customer relationships as possible. In this environment, the consumer interested in other services and/or in comparing services has to research each service provider's offerings independently.

Hence, a need exists to provide promotional content of one or more affiliated enterprises on a single interface.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an example network environment for providing promotional content.

FIG. 2 illustrates a flow chart useful for understanding an exemplary process for providing promotional content.

FIG. 3A is an example of a screenshot of a user interface for obtaining a location where a product or service will be provided.

FIG. 3B is an exemplary screenshot identifying affiliated providers that provide products and/or services at the location provided in FIG. 3A.

FIGS. 3C and 3D are exemplary screenshots of a sequence of user interfaces for logging into a site or system of an affiliated provider.

FIG. 3E is an example of a screenshot of available products and services at the provided location.

FIG. 3F is an exemplary screenshot of available options for the Internet service package if selected from the screen depicted in FIG. 3E.

FIG. 3G is an example of a screenshot of a user interface for completing a sales transaction for one or more options selected from FIG. 3F.

FIG. 4A is an example of a screenshot of an initial user interface.

FIG. 4B is an example of a screenshot of available products and services offered by one or more affiliated providers.

FIGS. 4C and 4D are screenshots of available premium services and products for cable services, upon selection the order cable service option of FIG. 4B.

FIG. 4E is an example screenshot of a calendar, which may be used to receive a user desired installation date for cable services.

FIG. 4F is an exemplary screenshot of available payment options for the cable services option.

FIG. 4G is an example of a screenshot of a confirmation for payment of cable services option of FIG. 4B.

FIG. 5 is a simplified functional block diagram of an example computer that may be configured as a host or server in the network environment of FIG. 1.

FIG. 6 is a simplified functional block diagram of an example personal computer or other workstation or terminal device in the network environment of FIG. 1.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to systems and methods for providing promotional content of one or more affiliated providers to a customer. Affiliated providers are enterprises that through contractual or corporate family relationships permit one provider to engage in cross channel promotions and/or sales of similar and/or identical products and/or services of one or more of the other providers, e.g. for display via a user interface to a customer of the providers and/or to an agent of the one provider. In at least some cases, the one provider presenting the information for the customer is a competitor of another provider from whom the information is obtained for presentation to the customer. Promotional products and/or services of different affiliated providers, for example, may be provided side by side with respect to each other on the user interface to allow the customer and/or agent to identify and compare the promotional products and/or services. In some of the more specific examples discussed below, the providers offer various communications services or related products. For such examples, the affiliated providers include enterprises that offer a range of products and/or services, including but not limited to internet services, internet service related products, television services. Landline phone services, mobile phone services and related wireless data communication services, and mobile device products. A system of a provider that has access to systems and information of affiliated providers can obtain promotional content from the affiliated providers and provide the obtained promotional content for presentation to the customer, for example, via a terminal device of or for use by the customer or to an agent of the one provider via a terminal. In the agent terminal examples, the agent of the one provider interacts with the customer using the promotional content.

In some examples, the system of the provider that is to interact with the customer obtains content from a provider system in response to an inquiry, e.g. at the time of the inquiry. In other examples, the system also stores the obtained promotional content at accessible storage location (e.g., datastore of the system, etc.). In an example of this later implementation, the system accesses the obtained promotional content from the storage location and provides the obtained promotional content for presentation when needed to answer a particular inquiry the customer or by an agent that may be interacting with the customer.

As outlined above, information about products and/or services of the affiliated providers may be provided to the customer across several channels. In some examples, products and/or services of the affiliated providers are displayed via a user interface on an electronic device of the customer. Examples of such devices include computer terminals communicating through the Internet, customers' mobile devices, as well as customer kiosks at retail stores of one of the providers. In other examples, the products and/or services of the affiliated providers are displayed via the same or similar user interface on a device of an agent of the one provider, for example, at a retail location or a call center of one of the affiliated providers. In these latter agent cases, the agent is able to observe the content and use the content to engage in cross channel marketing and sales interactions with the customer, e.g. in person at the retail location or via a mobile or landline telephone from the call center.

The customer may indicate an inquiry, with regard to products and/or services of one or more affiliated providers. In some examples, this indication may originate from a mobile device of the customer, a computer terminal of the customer or a kiosk available to the customer at a retail location. In other examples, this indication may originate from an agent operating a point of sale system at a retail location of one of the providers or an agent at a call center of one provider.

When a product or service inquiry is generated and is received at a portal computer system of a provider, the portal computer system determines a location where the product or service identified via the inquiry will be provided. The portal computer system then identifies, based on the location where the product or service will be provided, a subset of the affiliated providers that offer the identified product and/or service. The subset of providers is limited to those that provide services and/or products at the determined location, particularly the product or service to which the inquiry relates. In some cases, the provider whose portal is handling the inquiry may not carry the identified product and/or service but has access to an affiliated provider that carries the identified product and/or service. For each respective affiliated provider identified in response to the inquiry, the portal computer system then obtains promotional content associated with the identified product or service. By way of an example, if the inquiry is about bundled landline telephone, Internet and television services by a particular customer, the content obtained in answer to the inquiry might include such services offered by any one or more of the affiliated provider that currently offers the bundled services to the home address of the customer where the customer indicates a possible desire to receive the identified communication services. The portal system may also implement other algorithms for selecting or screening content, e.g. based on pricing and/or agreements about territories where offerings of different ones of the affiliated providers may overlap.

In one example, the promotional content of an affiliated provider is stored on a server for the affiliated provider (e.g., a server that is owned by and/or under control of the affiliated provider) and is provided to the portal computer system upon request. In another example, the promotional content of the affiliated provider is hosted on the portal computer system.

The portal computer system may also receive information that identifies the customer. For example, the portal computer system may provide an interface for display on the customer's electronic device, where the interface allows the customer to enter additional information, such as login credential to log into a system or site of at least one of the affiliated providers.

The portal computer system then transmits the obtained promotional content to an appropriate device for presentation to the customer. In one example, the appropriate device is the device which the product and/or service inquiry was generated from, although the device may be one operated by the customer or by an agent of the provider. As outlined earlier, examples of the device include a mobile device of the customer, a customer kiosk, a computer terminal of the customer, a point of sales system for an agent at a retail location of the provider, and an agent terminal at a call center of the one provider. An interface may be provided to the device to display the obtained promotions. In one example, the promotional content is provided for display via an application programming interface of an affiliated provider terminal or the customer's electronic device.

The portal computer system may also receive a customer selection of one or more of the products or services offered by the provided promotional content. The portal computer system may then initiate a sales transaction for the selected promotional content independent of which of the affiliated providers offers the product/service. Upon initiation of the sales transaction, the customer and/or agent is prompted to select from one of one or more acceptable payment methods (e.g., cash, check, credit card, etc.), which may differ based on the device that generated the product and/or service inquiry. For example, if the inquiry was generated by the mobile device of the customer, then only credit cards may be accepted as a method of payment. However, if the inquiry was generated from a point of sales system at a retail location of the provider, then cash, check, and credit cards may be accepted as payment methods. Some acceptable payment methods (e.g., credit card payments, etc.) require the user to provide financial information to process. If user financial information is required for to process payment, the financial information may be transmitted to a payment processor system (e.g. a remote system for processing credit card payments, etc.) for processing. The payment processing system processes the payment based on the provided financial information, determines whether the payment has been accepted and/or rejected and notifies the portal computer system of whether the payment has been accepted and/or rejected. Once the portal computer system receives an indication that the payment has been accepted, and the sales transaction is complete, the portal computer system provides information about the transaction to the computer system of the provider that will actually deliver the selected product or service to the customer at the determined location.

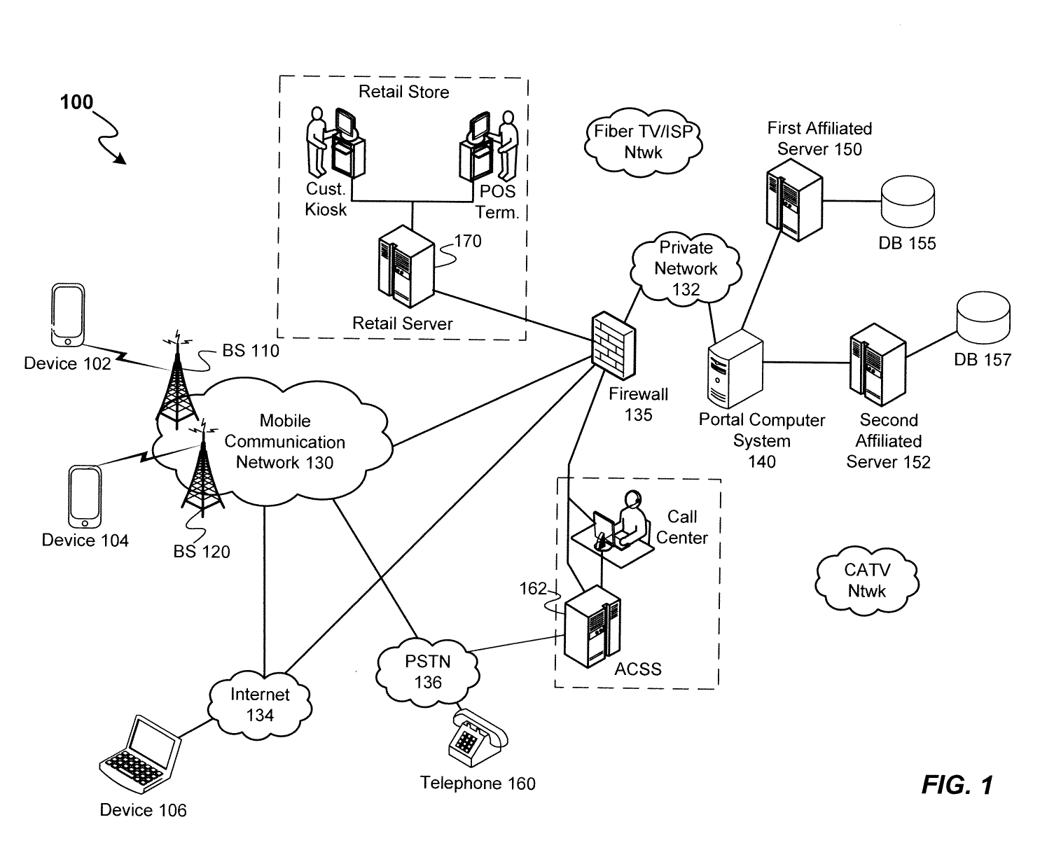

Reference now is made in detail to the examples illustrated in the accompanying drawings and discussed below. FIG. 1 illustrates an example network environment for providing promotional content through a portal and across multiple sales channels of one of a number of affiliated providers. In the example illustrated in FIG. 1, network environment 100 includes a mobile communication network 130 that provides mobile communication services to users of mobile devices such as devices 102 and 104. The carrier that operates the mobile communication network is one of a number of providers that offer communications services and products. As discussed more later, the provider that operates the network 130 also operates systems that facilitate communications between various electronic devices 102, 104 and 106 and at least one server via different sales channels. To that end, the system supports content and related sales communications through various types of networks including, but not limited to, a private network 132 and the Internet 134. Sales channels can include voice call communications with an agent at a call center, for example, from a mobile telephone example of a device 102 or 104 of a landline telephone 160 via the public switched telephone network (PSTN) 136. Another sales channel involves data communications with user devices such as mobile data enabled mobile device 102 or 104, an internes connect terminal device such as 106 or even a customer kiosk at a retail location. A still further sales channel involves an agent interaction with a customer at a retail location, in which case, the agent accesses the information and interacts with data components of the system via an agent terminal at the point of sale (POS) in the retail facility. The system 100 supports cross-channel sales in that promotional content and related sales activities are available across all of these channels between the one provider and relevant customers. As discussed further below, the content and transactional capabilities also extend across multiple providers to offer products and services of multiple providers to each customer that uses any of the channels.

Users' own devices, such as mobile devices 102 and 104 and Internet connected computer devices such as 106 access an on-line sales channel using respective data communications capabilities and networks. In the example, the devices 102, 104, 106 communicate via a firewall 135 and private data network 132 with a portal computer system 140, to obtain promotional content and/or to conduct interactive communications to implement desired sales transactions. For example, a user of any of these devices may input location information and an inquiry, which are sent to the portal computer system. The portal computer system in turn obtains responsive promotional content and sends the content back to the respective device for presentation to the user/customer. Similar communications may be provided via a customer kiosk at a retail store of the provider that operates the portal computer system.

Mobile devices 102 and 104 each can be any type of mobile telecommunication device with at least one processor, a memory, a display and one or more user input devices (e.g., a touch-screen display, QWERTY keyboard or T9 keypad). Examples of such mobile telecommunication devices include, but are not limited to, portable handsets, smart-phones, tablet computers and personal digital assistants. Similarly, device 106 can be any type of desktop or personal computing device with at least one processor, a memory, a display, one or more user input devices and at least one network communication device for communications through one or more different types of networks (e.g., mobile communication network 130 via a wireless network card integrated with or coupled to device 106). While only devices 102, 104 and 106 are shown in FIG. 1, network environment 100 can be used to facilitate data communications for additional devices (not shown). Also, while not shown in FIG. 1, each network in network environment 100 includes intermediate network routers, gateways or servers between network components/devices.

The call center handles voices calls, as one of the sales channels under consideration here. An automated customer support system (ACSS) 162 arranged at the call center can distribute calls from telephone 160 as well as other customer devices such as 102 or 104 to agent stations. If the calling station can be identified, e.g. from caller ID or related data accompanying the incoming call, the ACSS may also provide data about the account associated with the calling station to the terminal device (e.g., desktop terminal devices, mobile terminal devices, etc.) at the assigned agent station for various agent options. The terminal and ACSS also provide a system through which the agent can input information based on verbal interaction with the caller.

In one example, the agent receives an inquiry from a customer regarding products and/or services, and the agent utilizes an interface on her terminal device at the call center to input that inquiry for further processing. The interface provided by the ACSS and associated agent's terminal may allow the agent obtain promotional content for the agent to present verbally to the calling customer and/or to initiate a sales transaction, by performing a series of actions or steps.

Retail Server 170 may be a retail server for enabling retail transactions associated with physical sales channels. The channels in our example include point of sale (POS) channels at a retail store location. The POS terminal in this example is operated by an agent of one of the providers, e.g. the provider that operates the mobile network 130. The POS terminal and retail server may offer an interface for obtaining promotional content and interaction for conducting a sales transaction similar to that provided via the agent terminal and ACSS at the call center (except for the incoming call distribution).

For the customer kiosk, the retail server 170 may provide data communication with the network(s) and portal computer system 140 to provide an interactive interface similar to that on the customers' own data devices 102, 104, 106 as outlined earlier. Alternatively, the server 170 may be configured to control kiosk operations and the like in a manner intended to support the agent based retail sales channel. In an example of this later configuration, the server 170 may provide functions including, but not limited to, an automated kiosk channel with various kiosks for users at different physical locations and/or a physical retail store channel of the provider. In one such example, the kiosk is used to collect customer information before the agent at the point of sale terminal is available.

As noted earlier, in our example, the provider that offers the various sales channels is the carrier that operates the mobile communication network 130, and both voice and data channels for at least some of the customers extend through that network 130. For purposes of discussion, mobile communication network 130 will be described in the context of a network supporting both CDMA and 3rd Generation Partnership Project (3GPP) network technologies including, for example and without limitation, 3GPP type 2 (or 3GPP2) and 3GPP Long Term Evolution (LTE, at times also referred to as 4G). As described above, network 130 may use separate communication channels and radio access networks for communicating voice and data, respectively, to mobile devices 102 and 104. In an example, the radio access network for data communications is a 3G or 4G data network using 3GPP or 4G LTE technology and the radio access network for voice calls is a CDMA network using 1xRTT. However, it should be noted that the present techniques are not intended to be limited thereto and may be implemented using other types of mobile communication network technologies that do not provide simultaneous voice and data communications for mobile devices, as described above.

Mobile communication network 130 provides communications between mobile devices 102 and 104 as well as communications for other mobile devices on mobile communication network 130 and other devices outside of mobile communication network 130 (e.g., devices on third-party communication networks). An inter-carrier or other intermediate network gateway may provide communication connectivity between mobile communication network 130 and other networks. Mobile communication network 130 allows respective users of mobile devices 102 and 104 to initiate and receive telephone calls to each other as well as through the public switched telephone network (PSTN) 136 with one or more telephone stations 160 connected thereto. In an example, mobile communication network 130 offers a variety of text and other data services, including services via the Internet 134, such as downloads, web browsing, e-mail, etc. via various web servers (not shown) as well as message communications with terminal personal computing devices represented generally by device 106.

In some implementations, mobile communication network 130 includes a number of interconnected access networks for providing voice and data communication services to mobile device subscribers/users. Hence, the overall network 130 may include a number of radio access networks (RANs), as well as regional ground networks interconnecting a number of RANs and a wide area network (WAN) interconnecting the regional ground networks to core network elements. A regional portion of network 130, such as that serving mobile devices 102 and 104 will typically include one or more RANs and a regional circuit and/or packet switched network and associated signaling network facilities. Physical elements of a RAN are generally operated by a mobile network operator or wireless carrier of mobile communication network 130. Such physical elements include a number of base stations, as represented in the example shown in FIG. 1 by a base station (BS) 110 and a base station 120.

Although not separately shown, each of base stations 110 and 120 may include a base transceiver system (BTS). A BTS communicates via an antennae system at the site of the respective base stations 110 and 120 via an over-the-air communication link with one or more mobile devices that are within a particular signal coverage range of the BTS. The BTS is the part of the radio network that sends and receives RF signals to/from mobile devices 102 and 104, as served by base stations 110 and 120, respectively. In this example, the BTS utilizes CDMA type transceiver equipment and implement communications in accord with the protocols of the applicable 3GPP2 standard, for signaling, registration, voice communication, data communication, etc. Thus, each of base stations 110 and 120 is configured to broadcast certain standardized information (e.g., in accordance with CDMA or LTE communication protocols) to mobile devices 102 and 104 in addition to other mobile devices (not shown) within range of the particular base station so as to enable each device to find and establish a communication link with the base station via mobile communication network 130.

The radio access networks of mobile communication network 130 also include a mobile traffic network for voice communications between each mobile device, base stations 110 and 120 and other network elements. Individual elements (e.g., switches, gateways and/or routers) forming the traffic network are omitted from FIG. 1 for ease of discussion. Although not separately shown, the mobile communication network 130 will include or communicate with a number of service control elements. Such service control elements may include, for example, elements for authenticating mobile devices 102 and 104 to access mobile communication network 130. Additionally, such elements may include authorization control elements for authorizing users or devices for accessing various communication services and features offered by network 130. Further, such elements may include a billing system for purposes of usage accounting and billing functions of network 130. Some of these authentication or authorization functions may require credentials information from the mobile devices or their respective users (e.g., on a periodic basis for security reasons).

The above-described traffic network portion of mobile communication network 130 connects to a public switched telephone network (PSTN) 136, as shown in FIG. 1. This allows the network 130 to provide connections for voice calls between mobile devices 102 and 104 and a conventional landline telephone 160 connected to PSTN 136. Although only telephone 160 is shown in FIG. 1, any number of telephones in various physical locations may be connected to PSTN 136. Further, the traffic network portion of mobile communication network 130 also connects to a public packet switched data communication network. Such a packet switched data network may include the World Wide Web or the Internet, shown at 134 in FIG. 1. Packet switched communications via the traffic network of network 130 and the Internet 134 may support a variety of user services for mobile device communications. Examples of such services may include, but are not limited to, text and multimedia messaging services, electronic mail (“e-mail”), web browsing, and the downloading of new application programs and online media content. For example, the mobile devices may be able to send and receive messages to and from a user terminal device, e.g., personal computing device 106, via a direct (e.g., peer-to-peer) connection or through various intermediate servers.

The carrier or service provider that operates the mobile communication network 130 will also operate a number of systems that provide ancillary functions in support of the communications services provided through network 130, e.g. for maintaining customer account records, for processing usage data for customer billing, for storing promotional content regarding that carrier's products and services and for transactional processing for new product or service sales transactions. Network elements, as described above, may be configured to communicate with each other via a private network 132. In some implementations, private network 132 is an Internet Protocol (IP) based packet data network behind a firewall 135 or security layer that functions to maintain secure communications between the system components of the private network 132 by preventing unauthorized access by devices via other networks.

For purposes of the promotional and sales activities under consideration here, one or more systems will similarly connect to and communicate through the network 132. In the example of FIG. 1, such system components include a portal computer system 140 of a provider, a first server 150 for a first affiliated provider, and a second server 152 for a second affiliated provider that are communicatively coupled to each other via private network 132. Affiliated providers are enterprises that permit a provider to engage in cross channel promotions of similar and/or identical products and/or services and to provide their respective promotions for display via a user interface to a customer and/or to an agent of the provider for presentation to the customer. Promotional products and/or services of different affiliated providers may be provided side by side with respect to each other via the user interface to allow the customer and/or agent to identify and compare the promotional products and/or services.

The providers involved may opt for an arrangement of systems that store and provide content to the portal and associated procedures for access by the portal that best conforms to the relationships between the various providers, and several such arrangements have been outlined in the earlier discussion. For example, in scenarios in which most or all of the providers compete in at least some of their territories, the providers may prefer arrangements and procedures that enable each provider to maintain as much control as possible over the promotional content for their respective products and services and over the information about their respective customers. To that end, the example of FIG. 1 shows an arrangement in which the promotional content and any other information to be used by the system, for each affiliated provider, is stored in a database 155 or 157 and accessed via a server or the like 250, 253 that is owned by and/or under control of the particular affiliated provider. In the exemplary arrangement, the portal computer system 140 obtains information as needed by sending a request to the affiliated provider's server 150 or 152, as part of the processing and/or subsequent transactional activities following receipt of a customer inquiry via one of the sales channels.

For convenience, only the server/databases of only two of the affiliated providers are shown in the drawing. One set may be that of the provider/carrier that operates the portal computer system 140. Alternatively, the provider/carrier that operates the portal computer system 140 may store its content and other information on or in close association with the portal computer system 140 for direct access, in which case the servers 150, 152 and databases 155, 157 are those of other affiliated providers.

The portal computer system 140 may be coupled with additional servers (not shown) for additional affiliated providers and databases (not shown) that contain promotional content for the other affiliated providers. In the example of FIG. 1, the first affiliated server 150 includes database 155 and the second affiliated server 152 includes database 157. Database 155 and 157 may be used to store promotional data for the first and second affiliated servers 150 and 152, respectively to be processed and/or communicated by portal computer system 150 to electronic devices 102, 104, and 106. The portal computer system 140 accesses database 155 and 157 of the first and second affiliated servers and may provide promotional content that is stored on database 155 and 157 for presentation to the customer. From the perspective of the device 150 or 152, the portal computer system 140 would appear as a client. When information from a database is needed for a response to a customer inquiry, the portal computer system sends an appropriate request to the respective server 150 or 152. If access is permitted, e.g. for the involved customer, then the server in turn obtains the necessary information from its associated database 155 or 157, formats the retrieved information in an agreed form and supplies the information back to the portal computer system 140 for transmission as promotional content back through the sales channel through which the system 140 received the inquiry.

Typically, a customer will have an existing relationship with at least one of the providers, and the first provider with whom the customer has such a relationship is designated as the ‘home’ provider of that customer. A new customer may be assigned to one of the providers as the home provider, when the customer first purchases a product or services of one of the providers. The system of FIG. 1 can present content and conduct sales, in a number of different customer relationship scenarios. For example, the customer may be a customer of the provider that operates the portal computer system 140. In such a case, the portal computer system 140 may offer the customer information about services or products offered by the provider as well as information about products or services of one or more of the other providers. In another exemplary scenario, the customer is a customer of a different provider rather than the provider that operates the portal computer system 140. In such a case, the portal computer system 140 may offer the customer information about services or products offered by the other provider, services or products offered by the provider that operates the portal computer system 140 and/or products or services of one or more other providers.

Before promotional content is made available for the customer, the portal computer system 140 may check to confirm that the customer is one authorized to receive content from multiple providers. The system may also check with the home provider for information about the customer, for example, for a credit check or the like to determine if the customer is in good financial standing before completing a new sales transaction. In an example using a system configuration like that of FIG. 1, customer data may reside with the home provider, e.g. on or accessible to the home provider's server computer system 150 or 152. Such an arrangement allows each provider to maintain its own customer data, with minimal customer data sharing between providers. With such a configuration, the portal computer system 140 checks with a server 150 or 152 of the home provider when some promotional content delivery function or a transactional function involves customer authentication or authorization, e.g. to determine if a particular customer is authorized to receive promotional content from multiple providers through the portal or for a credit check or the like. In an alternative arrangement, in which the providers agree to share customer data more extensively, the portal computer system 140 may have customer information obtained in advance from various providers, stored on or in close association with the portal computer system 140 for direct access.

As shown in FIG. 1, electronic device 102, 104, or 106 may provide a product or service inquiry of one or more affiliated providers. In the example of FIG. 1, device 102 corresponds to a smartphone type mobile device of a customer, device 104 corresponds to a tablet type mobile device of a customer and device 106 corresponds to a computer terminal of the customer. The kiosk as well as the agent stations at the point of sale and the call center may be any type of appropriate computer or other suitable electronic device with data communication capabilities. Any of electronic devices 102, 104, or 106, may generate a product or service inquiry of one or more of the affiliated providers. Similarly, any of the agent terminals at a POS or a call center may generate a product or service inquiry of one or more of the affiliated providers, e.g. based on an agent's verbal interaction with a customer. The generated inquiry may be transmitted across mobile the communication network 130, internet 134 and/or PSTN 136 to the portal computer system 140. The portal computer system 140, upon receipt of the product or service inquiry, determines a location where communication product or service will be provided to the customer, e.g. from information included in the inquiry for from information known about the customer for whom the inquiry is being made. The portal computer system 140 may request the customer to provide a physical location. Alternatively, the portal computer system 140 may request customer identification information and look-up and identify a physical location of the customer from a database and then ask for customer confirmation that the location identified from the database lookup is the correction location for providing the product or service to which the inquiry relates. Based on the identified location, the portal computer system 140 identifies servers of affiliated providers (e.g., the first affiliated server 150, the second affiliated server 152, etc.) that offer communication products and/or or services corresponding to the inquiry at the determined location.

The portal computer system 140 then obtains promotional content for products and services and transmits the obtained promotional content to electronic devices 102, 104, and 106 and/or telephone station 160 via the mobile communication network 130, the internet 134, and/or the PSTN 136.

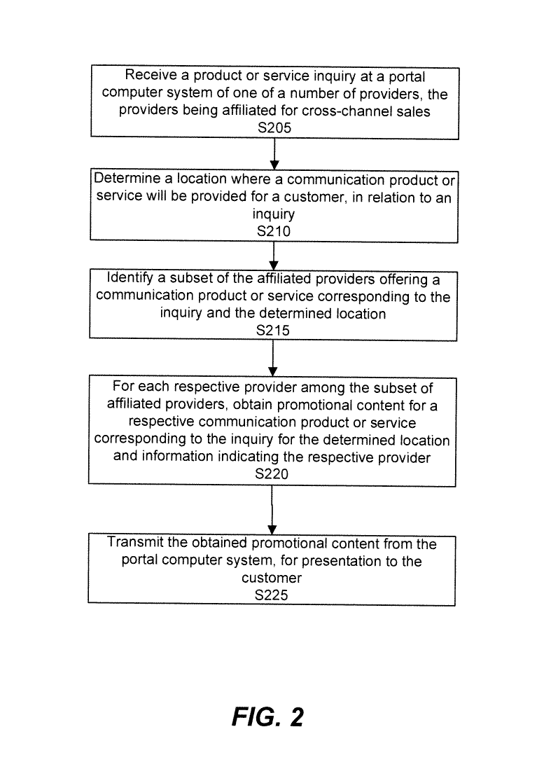

FIG. 2 illustrates a flow chart useful for understanding an exemplary process for providing promotional content. Although the operations in process 200 are shown in a particular order, certain operations may be performed in different orders or at the same time. Furthermore, although process 200 is described with reference to portal computer system 140 of FIG. 1, process 200 is not limited to such and can be performed by other computer systems.

A portal computer system 140 for a service provider that has access to promotional content provided by affiliated providers may obtain the promotional content and provide the obtained promotional content for presentation to the customer. In an example illustrated in FIG. 1, the obtained promotional content is not maintained on portal computer system 140. In such a case, the portal computer system 140 obtains the promotional content from a system of each of the affiliated providers (e.g., from the first affiliated server 150, and/or from the second affiliated server 152 etc.) and provides the obtained promotional content for presentation to the customer on a per request basis. Although the servers 150, 152 and associated databases may be operated by respective providers, they also could be operated by trusted third part information technology service providers with the content and functions still under control of the respective affiliated service/product providers. In other examples, the obtained promotional content is stored on or in close association with portal computer system 140 for direct access by the portal computer system 140. In this latter case, once the obtained promotional content has been stored on the portal computer system 140, the obtained promotional content may be retrieved and provided directly from the portal computer system 140 for responses to customer inquiries.

As shown in FIG. 2, the portal computer system 140 receives a product or a service inquiry of affiliated providers for cross-channel sales in block S205. As outlined earlier, the provider that operates the portal computer system 140 offers the promotional content of the affiliated providers across all of that one provider's channels.

The inquiry may be generated by any of the customer's electronic devices, by a customer accessible terminal of the provider (e.g. a customer accessible kiosk), or by any of the agent terminals at retail locations or call centers. Although a similar process may apply for other channels, for convenience of discussion of an example, mobile device 104 accesses a web site of an affiliated provider that is associated with the portal computer system 140, where the website contains a link that allows the customer to view promotional content from one or more affiliated providers. An indication that the customer is interested in promotional content of the affiliated providers is then transmitted from the mobile device 104 to the portal computer system 140 via the mobile communication network 130. The inquiry may be generated from a point of sale system at a retail location of the provider. The inquiry may also be generated from a computer terminal of the customer. Furthermore, the inquiry may also be generated by a mobile device 102 of the customer. Furthermore, the inquiry may also be generated from a call center of the provider.

In block S210, the portal computer system 140 determines a location where a communication product or service will be provided to a customer. In one example, the portal computer system 140 provides an interface for display on the customer's electronic device 102, 104, or 106. The customer is prompted to provide, via the interface, a physical location (e.g., zip code, street address, a point of interest, etc.) to the portal computer system 140. In block S215, the portal service provider 140 identifies a subset of affiliated providers that offer communication products or services corresponding to the inquiry for the determined location. In some examples, names of affiliated providers that offer communication products or services are provided for display via a user interface, e.g. on the customer's electronic personal device 102, 104, or 106 or a customer accessible kiosk or via the same or similar user interface on a device of a sales agent at a retail location or of an agent at a call center. The customer may select one or more of the displayed names and only products and/or services for the selected one or more affiliated providers are provided, on the customer's electronic device or the appropriate agent terminal. Although the user interface on the customer and agent equipment may be the same or similar, in other examples, the user interface for the customer may be customized differently from the user interface for the agent. For example, the user interface for the sales agent at the POS and/or the sales agent at the call center may contain additional features that allow the sales agent to access accounting tools as well as multiple customer accounts. Furthermore, a different user interface may be designed for each type of electronic device which the user interface is compatible with.

In block S220, and for each respective provider among the affiliated providers, the portal computer system 140 obtains promotional content for a respective product or service corresponding to the inquiry for the determined location and information indicating the respective provider. In one example, the promotional content for the respective product or service of each provider may be hosted by a server for the respective affiliated provider. In such a first exemplary implementation, the portal system obtains the promotional content of a respective service provider from a remote server of that provider, as part of the portal computer system's processing responsive to the inquiry. In another example, the promotional content for the respective product or service may be stored in a component (e.g., RAM, ROM, mass storage device, etc.) of the portal computer system 140. In this case, the promotional content for the respective product or service may be retrieved from the storage component, as part of the portal computer system's processing responsive to the inquiry. In a further example, the promotional content for the respective product or service may be hosted by a remote server of a trusted but independent third party that the portal computer system 140 has access to.

The portal computer system 140 may also provide an interface for the customer to provide customer information (e.g., login credentials for a website of an affiliated provider, etc.) to identify the customer's association with the affiliated provider. In this case, the portal computer system 140 receives information identifying the customer and from the identifying information, requests the server of the one or more of affiliated providers to determine whether the customer is eligible for additional promotions by the affiliated providers. The determination may be made by communication with a home provider associated with the particular customer or by querying the servers of the various providers to determine which ones will agree to provide content to the particular customer.

In one example, the additional promotions may be available to select customers. The additional promotions may include products and/or services that are only provided to the select customers. The terms of products and/or services may also be different for the select customers. The affiliated provider, upon verification of the customer information, determines if the customer is eligible for additional promotions and provides any additional eligible promotions to the portal computer system 140.

In block S225, portal computer system 140 transmits the obtained promotional content to the customer. The portal computer system 140 may provide an interface to display the obtained promotional content on the customer's mobile device 102, 104, or on a customer's computer terminal 106, on a customer accessible kiosk, on an agent's terminal of a point of sale system at a retail location, and/or on an agent terminal at a call center of the affiliated provider that operates the portal computer system 140. Although not shown, the portal computer system may also provide a similar system for agent terminals and/or customer kiosks operated by others of the affiliated providers and/or of third party re-sellers under contractual obligations with one or more of the affiliated providers. The portal computer system 140 in this way serves as a frontend portal for accessing product or service content for any of the providers that can deliver the product or service involved in the customer's inquiry to the desired location. The interaction through the portal, upon presentation of the content to the customer may also support sales transactions. The customer may select one of the communication products or services of the affiliated provider that are presented to the customer, e.g. by display on the customer device or customer accessible kiosk or by an agent viewing a display on any of the POS or call center agents' terminals. The selection by the customer is then received at the portal computer system 140 and a sales transaction is implemented via the portal computer system 140, including appropriate communications through the portal between the customer and the selected provider to provide the selected product or service to the customer at the determined location.

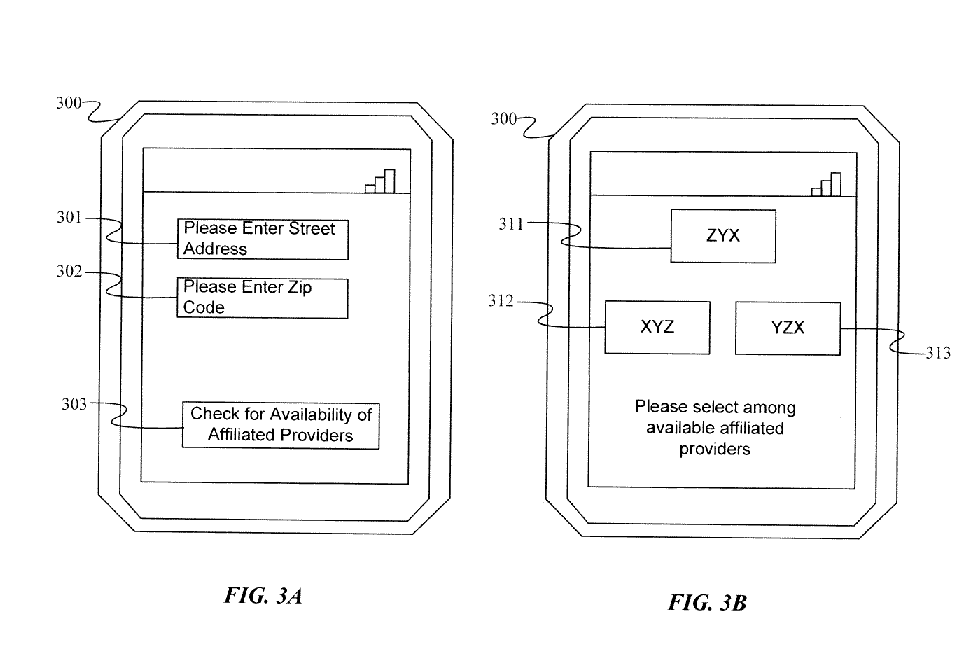

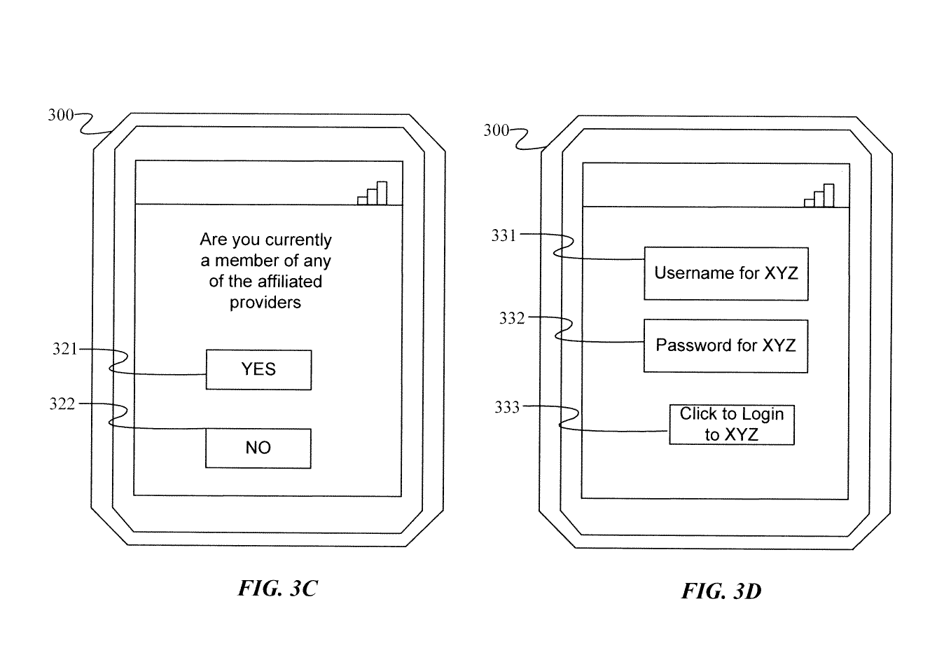

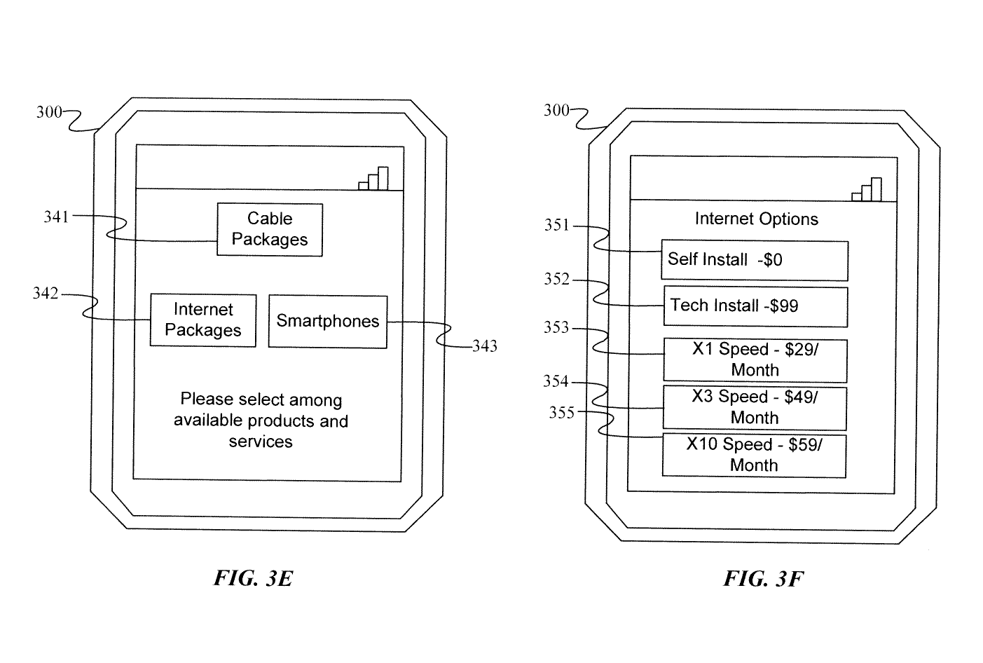

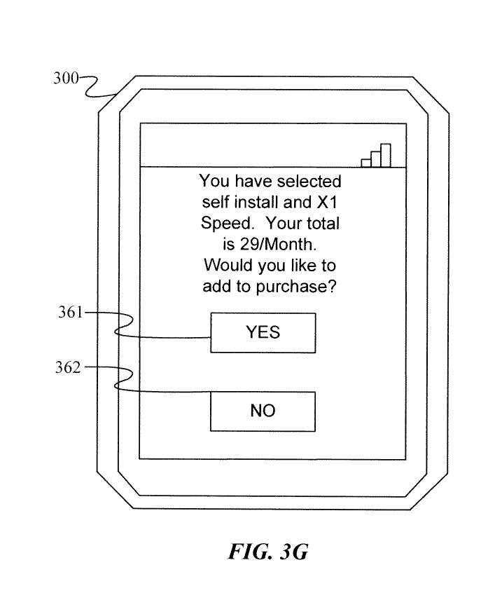

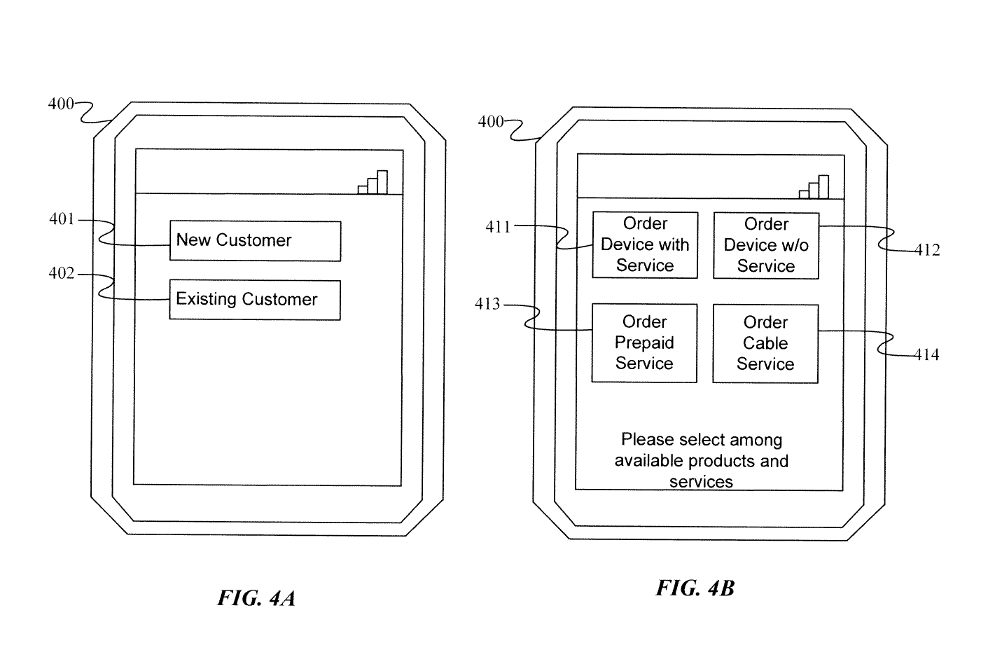

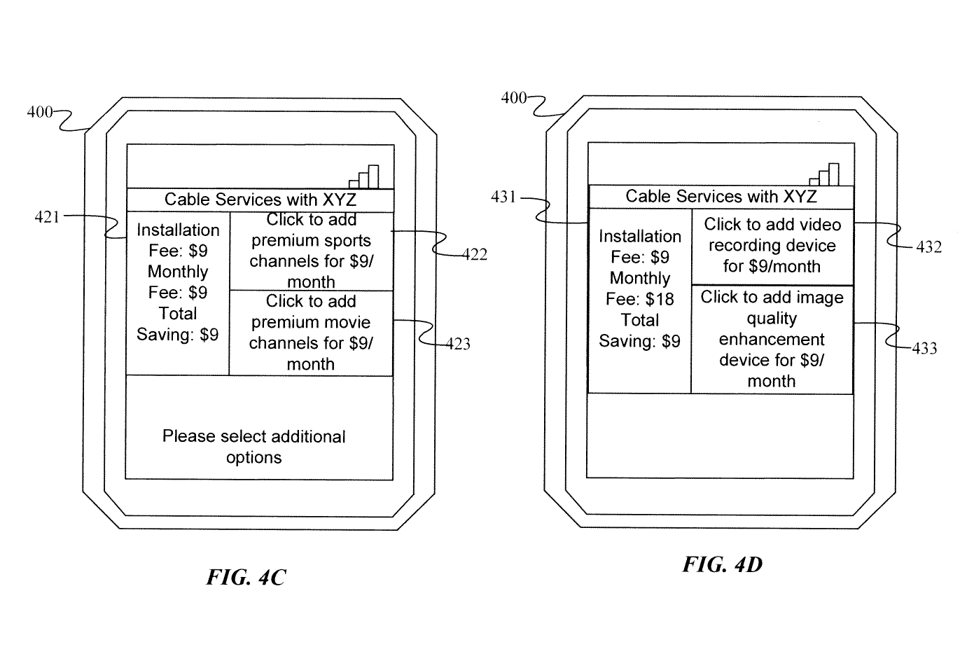

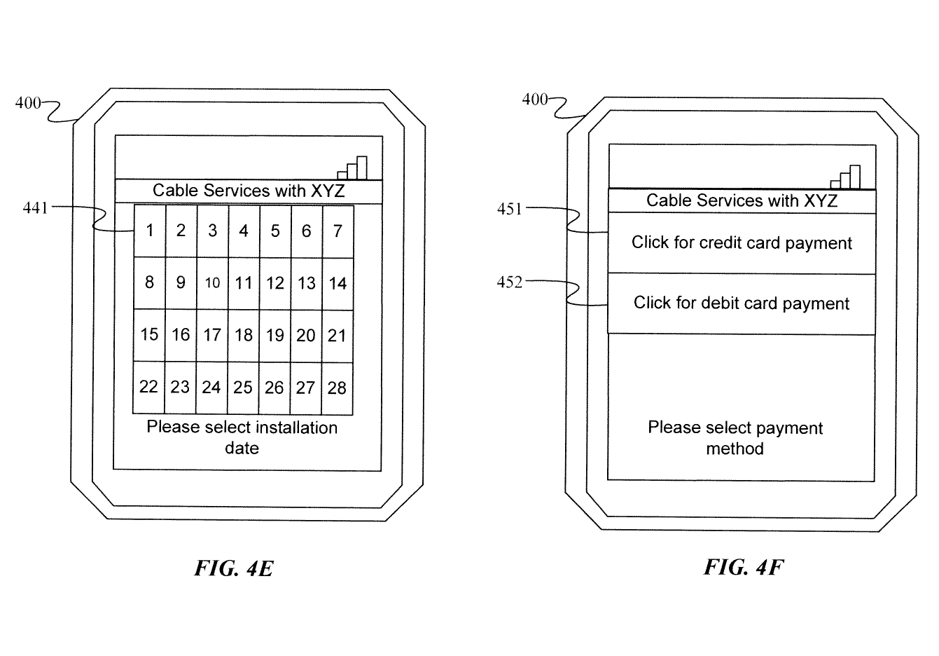

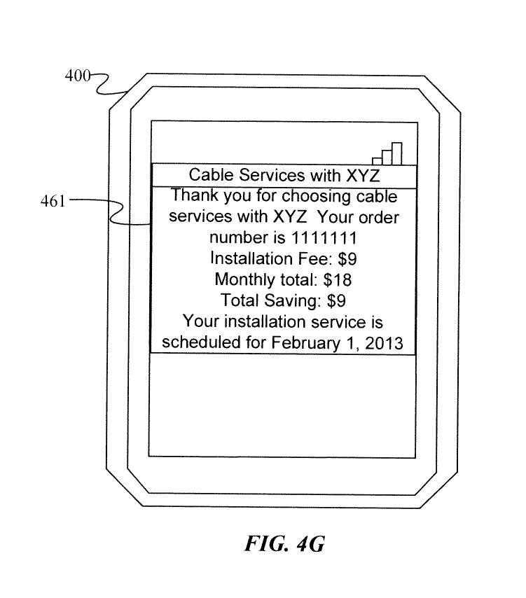

FIGS. 3A to 4G are exemplary screenshots, useful in understanding content presentation and possible inputs involved in several procedures that may be implemented for the cross-channel marketing and/or sales activities of affiliated providers. For purposes of illustration, the screenshots are depicted as screens that might appear on a mobile device such as a smartphone or tablet when held in a portrait orientation, although such a device may be operated by a customer or by an agent. Although not shown, similar displays could be presented for similar user interface functions on other types of devices as may be operated by customers or agents of a particular one of the affiliated providers.

FIG. 3A is an example of a screenshot of a user interface for obtaining a location where a product or service will be provided. As shown in FIG. 3A, a user interface is provided for display on tablet computer 300. The user interface includes an input box 301 that is configured to receive the customer's address and another input box 302 that is configured to receive the customer's zip code. In the example of FIG. 3A, the customer may enter the customer's street address and/or zip code. Upon a user selection of user control 303, the customer's inputted street address and/or zip code are transmitted to portal computer system 140. The portal computer system 140 then identifies one or more affiliated providers that offer products and/or services at the inputted location.

FIG. 3B is an exemplary screenshot identifying affiliated providers that provide products and/or services at the location provided in FIG. 3A. In some instances, the identified affiliated providers are not limited to providing products and/or services that are also provided by the provider at the inputted location. As shown in FIG. 3B, affiliated providers ZYX 311, XYZ 312, and YZX 313 are provided for display on the tablet computer 300. Three affiliated providers are identified in the exemplary display shown in FIG. 3B. The number of available affiliated providers that are displayed is based on the selected location. Therefore, a different location may yield a different number of affiliated providers. In the example of FIG. 3B, the customer may select one or any combination of the available affiliated providers, for example, based on the one or more services or product of interest to the customer at the time of the inquiry.

FIGS. 3C and 3D are exemplary screenshots of a sequence of user interfaces for logging into a site or system of an affiliated provider. In FIG. 3C, the customer may elect to indicate whether the customer is a member of the selected affiliated provider. In FIG. 3C, user control 321 is configured to allow the customer to indicate that the customer is a member of the selected affiliated provider and user control 322 is configured to allow the customer to indicate that the customer is not a member of the selected affiliated provider. If the customer selects user control 321, then an interface shown in FIG. 3D is displayed where the customer is prompted to provide the customer's login credential. As shown in FIG. 3D, input box 331 is configured to receive the customer's username and input box 332 is configured to receive the customer's password. User control 333 is configured to transmit the customer's login credential to the portal computer system 140 and/or the selected affiliated provider. Once the user login credential is verified, the portal computer system may have access to additional promotions that are available to the customer as a member of the affiliated provider.

FIG. 3E is an example of a screenshot of available products and services at the provided location. In the example of FIG. 3E, the customer may select from cable packages 341, internet packages 342, and/or smartphones 343. Other packages may also be available based the selected location, member promotions, etc.

FIG. 3F is an exemplary screenshot of available options for the Internet service package if selected from the screen depicted in FIG. 3E. As shown in FIG. 3F, the customer may select from two installation options 351 and 352 and three internet speed options 353-355. Where multiple packages are available, options for two or more packages may be simultaneously displayed on the display screen of tablet computer 300.

FIG. 3G is an example of a screenshot of a user interface for completing a sales transaction for one or more options selected from FIG. 3F. Once the customer has selected a product and/or service, the customer may elect to complete a transaction to purchase the product and/or service. As shown in FIG. 3G, the customer is provided with an option to accept or cancel the order by selecting user controls 361 and 362 respectively.

FIGS. 4A to 4G represent the user interface screens of a somewhat more detailed example. For purposes of this example, the provider that also operates the portal computer system offers mobile wireless communication services and devices that operate via the provider's network 130 to utilize those services. Other affiliated providers offer cable television services, landline phone services and/or internet services, e.g. through a cable television (CATV) network or through a fiber television and internet service provider (TV/ISP) network (see also FIG. 1). The TV/ISP network, for example, may be operated by an enterprise within the same corporate family that operates the mobile network 130, the call center and retail sales location and the portal computer system 140. The CATV network is operated by an independent enterprise that competes in at least some territories, e.g. with the corporate family member that operates the fiber TV/ISP network.

FIG. 4A is an example of a screenshot of an initial user interface display. As shown in FIG. 4A, a user interface is provided for display on tablet computer 400 with a touchscreen display. The user interface includes user control 401 that is configured to provide an indication to the portal computer system 140 that the customer is a new customer for the provider that operates the portal and a user control 402 that is configured to provide an indication to the portal computer system 140 that the customer is an existing customer for that provider. The customer, however, may be an existing customer of another of the affiliated providers. Although not separately shown, login procedures for either case 401, 402 will follow to allow the portal to obtain and verify identity of a customer, and confirm status if the customer is an existing customer of one of the affiliated providers. Some or all of the later functions of the interface through the portal may be controlled based on customer identification and association of the customer with a particular home provider, e.g. to limit content provided to a customer in accordance with permissions or rules controlled by the home provider or to confirm that the particular customer is one to whom the various providers have agreed that they may all provide content.

FIG. 4B is an example of a screenshot of available products and services offered by one or more of the affiliated providers. In our example, the products or services include some from other communication providers that are affiliated with the provider of the portal for promotion and sales purposes as well as communication service and products from the portal provider. As shown in FIG. 4B, the customer may select to order a device with service 411 (e.g. a mobile device and a wireless mobile service), device without service 412, prepaid service 413, and/or cable service 414. The cable service could be provided by the affiliated enterprise from the same corporate family as the wireless mobile provider and/or from one or more CATV service providers from outside the corporate family. The availability of different services from providers that are affiliated for promotions and sales through the portal computer system 140 may be based on the location of the customer, which in some examples, may be provided by the user interface of FIG. 3A.

FIGS. 4C and 4D are screenshots of available premium services and products for cable services option of FIG. 4B. As shown in FIG. 4C, cable services for affiliated provider XYZ are provided for display. In the example illustrated in FIG. 4C, only affiliated provider XYZ provides cable services at the customer's designated location. In other examples, where multiple affiliated providers provide a user selected product and/or service, an initial display may present content about such competing products/services of multiple providers. In this latter case, the customer may select a desired affiliated provider via the interface illustrated in FIG. 3B.

As shown in FIG. 4C, a cost menu 421, which displays the cost associated with the selected cable service, is provided. Furthermore, options for adding premium sports channels 422 and premium movie channels 423 are also provided. The cost menu 421 is configured to dynamically adjust the displayed cost associated with cable services with XYZ in response to a user selection of premium options 422 and/or 423.

In FIG. 4D, cost menu 431 and additional premium device options 432 and 433 are provided for display on the tablet computer 400. The cost menu 431 is also configured to dynamically adjust the displayed cost associated with cable services XYZ in response to a user selection of premium device options 432 and/or 433.

FIG. 4E is an example screenshot of a calendar, which may be used to receive a user desired installation date for cable services option of FIG. 4B. The calendar may indicate days which are open to the customer. The customer may select a desirable day for performing the installation via the calendar 441. In other examples, an input box that is configured to receive a user inputted date is provided for display on the tablet computer 400.

FIG. 4F is an exemplary screenshot of available payment options for cable services option of FIG. 4B. In the example illustrated by FIG. 4F, the customer may pay for the cable services via credit card payment 451 or debit card payment 452. Available methods of payment may be based on the device and/or location where the payment is being processed. In one example, if the transaction is handled by an agent at a retail location of XYZ, then cash payment may also be an available form of payment.

FIG. 4G is an example of a screenshot of a confirmation for payment of cable services option of FIG. 4B. As shown in FIG. 4G, confirmation 461 is provided for display on the tablet computer 400.

As shown by the above discussion, functions relating to providing promotional content for multiple providers via portal of one of those providers may be implemented on computers connected for data communication via the components of a network, operating as one or more of the servers as shown in FIG. 1. Although special purpose devices may be used, such devices also may be implemented using one or more hardware platforms intended to represent a general class of data processing device commonly used to run “server” programming so as to implement the promotional content-related functions discussed above, albeit with an appropriate network connection for data communication.

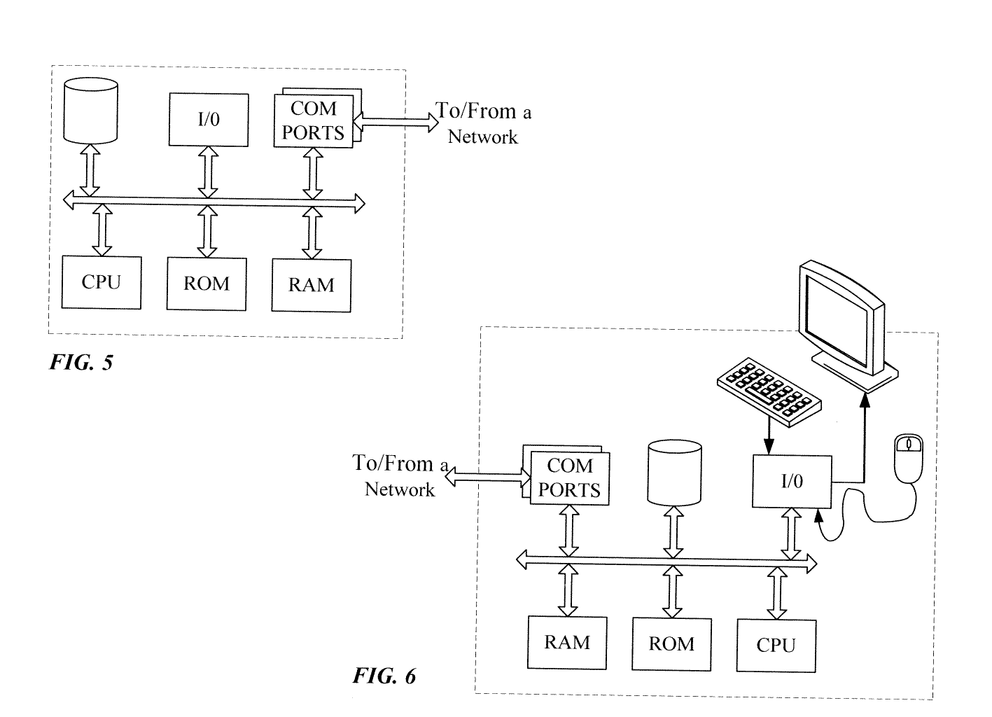

FIGS. 5 and 6 provide functional block diagram illustrations of general purpose computer hardware platforms. FIG. 5 illustrates a network or host computer platform, as may typically be used to implement a server (e.g., a server for Portal Computer System 140, server for first affiliated provider 150, server for second affiliated provider 152, etc. of FIG. 1). FIG. 6 depicts a computer or workstation device with user interface elements, as may be used to implement a personal computer (e.g., device 106 of FIG. 1, as described above), although such a computer also may be programmed/configured to operate as a server. It is believed that the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, aspects of the various network components of the mobile communication networks of FIG. 1 (e.g., portal computer system 140, first affiliated server 150, second affiliated server 152, etc.) as described above, may be embodied in programming. Program aspects of the technology may be thought of as “products” or “articles of manufacture” typically in the form of executable code or process instructions and/or associated data that is stored on or embodied in a type of machine readable medium, “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a system associated with the first affiliated server into a system associated with the second affiliated server.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as “computer’ or “machine readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the functions performed by the various network components of FIG. 1 as described above. Volatile storage media include dynamic memory, such as main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Although shown in a form generally representing a desktop computer, the computer as illustrated in the example of FIG. 5 may be a mobile computer with user interface elements, as may be used to implement a smartphone, a laptop, tablet or notebook computer or the like. For example, such a device may include a touch-screen display for user input and output. Alternatively, the device may include a standard light emitting diode (LED) display and, for example, an alphanumeric keypad or T9 keyboard. It is believed that the structure, programming, and general operation of such computing equipment and as a result the drawing should be self-explanatory. As known in the data processing and communications arts, a mobile computer comprises a central processor or other processing device, an internal communication bus, various types of memory or storage media (RAM, ROM, EEPROM, cache memory, disk drives, etc.) for code and data storage, and one or more network interface cards or ports for communication purposes. Also, the mobile computer can further comprise various wireless transceiver modules (or components) such as GPS, WiFi, IrDA, Bluetooth, etc. The software functionalities involve programming, including executable code, associated stored data, and graphical user interface code for implementing a client application program at the mobile device. The software code is executable by the processor of the mobile computer. In operation, the code is stored within the mobile computer. At other times, however, the software may be stored at other locations and/or transported for loading into the appropriate mobile computer. Execution of such code by a processor of the mobile computer enables the mobile computer to implement terminal device-side aspects of the promotional content delivery methodology, in essentially the manner performed in the implementation discussed and illustrated herein.

Further, the client can be implemented in a remote computer (or server) on a network. That is, a client device (e.g., mobile device) sends information (e.g. a request message) to the remote server for requesting access to a function of a web application hosted at the server; and the remote server processes the request based on the request received from the client and returns an appropriate response (e.g., including application data retrieved from a database) to the client over the network. In the example above, the client device operates as a client terminal and the remote computer as a server in a client-server network environment.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising steps of:
receiving a product or service inquiry at a portal computer system of one of a number of providers, the providers being affiliated for cross-channel sales;
determining, in response to receiving the inquiry, a location where a communication product or service will be provided for a customer to whom the inquiry relates;
identifying a subset of the affiliated providers offering a communication product or service corresponding to the inquiry for the determined location;
for each respective affiliated provider among the subset of affiliated providers, obtaining promotional content for a respective communication product or service corresponding to the inquiry for the determined location and information indicating the respective affiliated provider, from a computer system of the respective affiliated provider; and
transmitting the obtained promotional content from the portal computer system, for presentation to the customer.

2. The method of claim 1, wherein the subset includes a plurality of the affiliated providers and the method further comprises steps of:
receiving at the portal computer system of the one provider a selection by the customer of one of the plurality of the affiliated providers and a selection of a product or service of the selected provider; and
completing a sales transaction via the portal computer system, between the customer and the selected provider to provide the selected product or service to the customer at the determined location.

3. The method of claim 1, wherein:
the affiliated providers are enterprises that through contractual or corporate family relationships permit one of the providers to engage in cross channel promotions and/or sales of similar and/or identical products and/or services of one or more of the other providers, and
at least two of the affiliated providers are competitors of one another for a product or service.

4. The method of claim 1, wherein the inquiry is received from and the obtained promotional content is transmitted to a terminal device of an agent terminal at a retail location or at a call center of the one provider.

5. The method of claim 1, further comprising:
receiving information identifying the customer; and
from the identifying information, verifying that the customer has been approved for access to product offerings of each respective affiliated provider among the subset of affiliated providers.

6. The method of claim 1, further comprising:
receiving a login credential for a customer account with one affiliated provider among the subset of affiliated provider;
providing the login credential to a system associated with the one affiliated provider to access the customer account with the one affiliated provider; and
obtaining, from the system associated with the one affiliated provider, promotional content for the communication product or service that is available to the customer account.

7. The method of claim 1, wherein, for each respective affiliated provider among the subset of affiliated providers:
the promotional content for the respective communication product or service is hosted by a server associated with the respective affiliated provider, and
the promotional content for the respective communication product or service is obtained from the server associated with the respective affiliated provider.

8. The method of claim 1, wherein, for each respective affiliated provider among the subset of affiliated providers:
the promotional content for the respective communication product or service is provided for display via an application programming interface of the respective affiliated provider.

9. The method of claim 1, further comprising:
receiving a selection of one of the identified affiliated providers;
obtaining promotional content for the selected affiliated provider; and
providing for display, the obtained promotional content for the selected affiliated provider to an electronic device of the customer.

10. A system comprising:
a interface configured for communication via a network;
one or more processors coupled to the interface; and
a machine-readable medium comprising instructions stored therein for configuring the system as a portal computer system of one of a number of providers, the providers being affiliated for cross-channel sales, wherein when executed by the one or more processors, the instructions configure the one or more processors to perform operations comprising operations to:
receive a product or service inquiry at the a portal computer system, from the network and the interface;
determine a location where a communication product or service will be provided for a customer to whom the inquiry relates;
identify a subset of the affiliated providers offering a communication product or service corresponding to the inquiry for the determined location;
for each respective affiliated provider among the subset of affiliated providers, obtain promotional content for a respective communication product or service corresponding to the inquiry for the determined location and information indicating the respective affiliated provider, from a computer system of the respective affiliated provider; and
transmit, via the interface the obtained promotional content from the portal computer system, for presentation to the customer.

11. The system of claim 10, wherein when executed by the one or more processors, the instructions further configure the one or more processors to perform operations to:
receive at the portal computer system of the one provider a selection by the customer of one of the plurality of the affiliated providers and a selection of a product or service of the selected provider.

12. The system of claim 10, wherein when executed by the one or more processors, the instructions further configure the one or more processors to perform operations to:
receive information identifying the customer; and
verify, based on the received information, that the customer has been approved for access to product offerings of each respective affiliated provider among the subset of affiliated providers.

13. The system of claim 10, wherein when executed by the one or more processors, the instructions further configure the one or more processors to perform operations to:
receive a login credential for a customer account with one affiliated provider among the subset of affiliated provider;
provide the login credential to a system associated with the one affiliated provider to access the customer account with the one affiliated provider; and
obtain, from the system associated with the one affiliated provider, promotional content for the communication product or service that is available to the customer account.

14. The system of claim 10, wherein when executed by the one or more processors, the instructions further configure the one or more processors to perform operations to:
for each respective affiliated provider among the subset of affiliated providers:
the promotional content for the respective communication product or service is provided for display via an application programming interface of the respective affiliated provider.

15. A machine-readable medium comprising instructions stored therein for configuring the system as a portal computer system of one of a number of providers, the providers being affiliated for cross-channel sales, wherein when executed by the one or more processors, the instructions configure the one or more processors to perform operations comprising operations to:
receive a product or service inquiry at the a portal computer system, from the network and the interface;
determine a location where a communication product or service will be provided for a customer to whom the inquiry relates;
identify a subset of the affiliated providers offering a communication product or service corresponding to the inquiry for the determined location;
for each respective affiliated provider among the subset of affiliated providers, obtain promotional content for a respective communication product or service corresponding to the inquiry for the determined location and information indicating the respective affiliated provider, from a computer system of the respective affiliated provider; and
transmit, via the interface the obtained promotional content from the portal computer system, for presentation to the customer;
receive at the portal computer system of the one provider a selection by the customer of one of the plurality of the affiliated providers and selection of a product or service of the selected provider; and
complete a sales transaction via the portal computer system, between the customer and the selected provider to provide the selected product or service to the customer at the determined location.

16. The machine-readable medium of claim 15, wherein when executed by the one or more processors, the instructions further configure the one or more processors to perform operations to:
receive information identifying the customer; and
verify, based on the received information, that the customer has been approved for access to product offerings of each respective affiliated provider among the subset of affiliated providers.

17. The machine-readable medium of claim 15, wherein when executed by the one or more processors, the instructions further configure the one or more processors to perform operations to:
receive a login credential for a customer account with one affiliated provider among the subset of affiliated provider;
provide the login credential to a system associated with the one affiliated provider to access the customer account with the one affiliated provider; and
obtain, from the system associated with the one affiliated provider, promotional content for the communication product or service that is available to the customer account.
